(19) United States
(12) Patent Application Publication
(10) Pub. No.: US 2024/0318901 A1
(43) Pub. Date: Sep. 26, 2024

(54) REFRIGERATOR WITH MODULAR CARTRIDGES IN FLUID COMMUNICATION WITH THE WATER SUPPLY

(71) Applicant: Midea Group Co., Ltd., Beijiao (CN)

(72) Inventor: Gregory Butorin, Louisville, KY (US)

(21) Appl. No.: 18/188,087

(22) Filed: Mar. 22, 2023

(51) Int. Cl. F25D 23/12; B01D 29/56; B67D 1/00; C02F 1/00; C02F 1/50; C02F 1/68

(52) U.S. Cl. CPC F25D 23/126; B01D 29/56; B67D 1/0014; B67D 1/0078; C02F 1/003; C02F 1/50; C02F 1/68; B67D 2001/0818; C02F 2201/004; C02F 2201/006; C02F 2303/04; C02F 2307/10; C02F 2307/12; F25D 2323/121; F25D 2323/122

(57) ABSTRACT

A refrigerator apparatus and method utilizing one or more water cartridges to customize the water supply. The water cartridge may include a coupler. The water cartridge may include a cartridge head assembly. A plurality of water cartridges may be combined in fluid communication with each other to customize the water supply.

### BACKGROUND

Typical residential refrigerators generally include a water filter device provided with a water filter to purify water supplied from an external water supply source. However, the consumer has limited ability to customize/modify the filtering and/or the water supplied/used.

### SUMMARY

In some embodiments, a refrigerator may include a cabinet. In various embodiments, the cabinet may include a case having one or more food storage compartments defined therein and/or one or more doors positioned to access the one or more food storage compartments from an exterior environment. In various embodiments, the refrigerator and/or cabinet may include a refrigerator cartridge head assembly in fluid communication with a water supply. In some embodiments, the refrigerator may include one or more water cartridges. In various embodiments, at least a first water cartridge of the one or more water cartridges may include a housing having a first end and a second end. In some embodiments, the first end may include a first coupler releasably connected to the refrigerator cartridge head assembly between a first configuration wherein the first water cartridge is not in fluid communication with the refrigerator cartridge head assembly and a second configuration wherein the first water cartridge is in fluid communication with the refrigerator cartridge head assembly. In some embodiments, the first end may include a first coupler releasably connected to the refrigerator cartridge head assembly. In various embodiments, the second end may include a first cartridge head assembly. In some embodiments, the first cartridge head assembly may be configured to receive a second coupler of a second water cartridge.

In addition, in some embodiments, the one or more water cartridges may include a filter, a water tank, a sanitizer, and/or an additive. In various embodiments, the refrigerator may include a second water cartridge having a housing having a first end and a second end. In some embodiments, the first end may include a second coupler releasably connected to the first cartridge head assembly between a first configuration wherein the second water cartridge is not in fluid communication with the first cartridge head assembly and a second configuration wherein the second water cartridge is in fluid communication with the first cartridge head assembly. In some embodiments, the first end may include a second coupler releasably connected to the first cartridge head assembly. In various embodiments, the first coupler and the second coupler may be the same. In some embodiments, the first cartridge head assembly may include a first configuration and a second configuration. In various embodiments, when in the first configuration an inlet passage of the first cartridge head assembly may be closed. In some embodiments, when in the second configuration the inlet passage of the first cartridge head assembly may be open and configured to be in fluid communication with a second water cartridge. In various embodiments, two or more of the one or more water cartridges are in fluid communication with each other in series between a water supply line and a water discharge line connected to the refrigerator cartridge head assembly. In some embodiments, the refrigerator may include a dispenser, a container, and/or an ice maker in downstream communication with the refrigerator cartridge head assembly. In various embodiments, two or more of the one or more water cartridges may provide different properties to the water supply.

In some embodiments, a water cartridge for a refrigerator may include a housing having a first end and a second end. In various embodiments, the first end may include a first coupler configured to be releasably connected to a refrigerator cartridge head assembly of a refrigerator between a first configuration configured to not be in fluid communication with a refrigerator cartridge head assembly and a second configuration configured to be in fluid communication with a refrigerator cartridge head assembly. In some embodiments, the second end may include a cartridge head assembly. In various embodiments, the first end may include a first coupler. In some embodiments, the cartridge head assembly may be configured to receive a second coupler of a second water cartridge.

In addition, in some embodiments, the water cartridge may include a second water cartridge having a housing having a first end and a second end. In various embodiments, the first end may include a second coupler releasably connected to the cartridge head assembly between a first configuration wherein the second water cartridge is not in fluid communication with the cartridge head assembly and a second configuration wherein the second water cartridge is in fluid communication with the cartridge head assembly. In some embodiments, the first end may include a second coupler releasably connected to the cartridge head assembly. In various embodiments, the cartridge head assembly may include a first configuration and a second configuration. In some embodiments, when in the first configuration an inlet passage of the cartridge head assembly may be closed. In various embodiments, when in the second configuration the inlet passage of the cartridge head assembly may be open and configured to be in fluid communication with a second water cartridge. In various embodiments, the water cartridge may include a filter, a water tank, a sanitizer, and/or an additive. In some embodiments, the water cartridge may include the water tank, the sanitizer, and/or the additive. In various embodiments, the water cartridge may include a downstream water cartridge that is in fluid communication between an inlet and an outlet of the first coupler. In some embodiments, the water cartridge may be different than the downstream water cartridge.

In some embodiments, a method of assembling two or more water cartridges in fluid communication may include providing a first water cartridge having a housing. In various embodiments, the housing may have a first end and a second end. In various embodiments, the first end may include a first coupler. In some embodiments, the second end may include a first cartridge head assembly. In various embodiments, the method may include providing a second water cartridge having a housing. In some embodiments, the housing may have a first end and a second end. In some embodiments, the first end may include a second coupler. In various embodiments, the second end may include a second cartridge head assembly. In some embodiments, the method may include releasably connecting the second coupler of the second water cartridge in fluid communication with the first cartridge head assembly.

In addition, in some embodiments, the first cartridge head assembly may include a first configuration and a second configuration. In various embodiments, when in the first configuration an outlet of the first cartridge head assembly may be closed. In some embodiments, when in the second configuration the outlet of the first cartridge head assembly may be open and configured to be in fluid communication with the second water cartridge. In various embodiments, the method may include releasably connecting a third water cartridge to the second cartridge head assembly. In some embodiments, the method may include coupling the first water cartridge and the second water cartridge to a refrigerator cartridge head assembly of a refrigerator (e.g. in fluid communication between a water supply line and a water discharge line). In various embodiments, the method may include releasably disconnecting the second coupler of the second water cartridge out of fluid communication with the first cartridge head assembly.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a refrigerator consistent with some embodiments of the invention.

FIG. 2 is a sectional view of two water cartridges in fluid communication with a refrigerator cartridge head assembly.

FIG. 3 is an exploded view of FIG. 2 not in fluid communication with each other.

FIG. 4 is a sectional view of three water cartridges in fluid communication with a refrigerator cartridge head assembly.

FIG. 5 is an exploded perspective view of FIG. 4.

### DETAILED DESCRIPTION

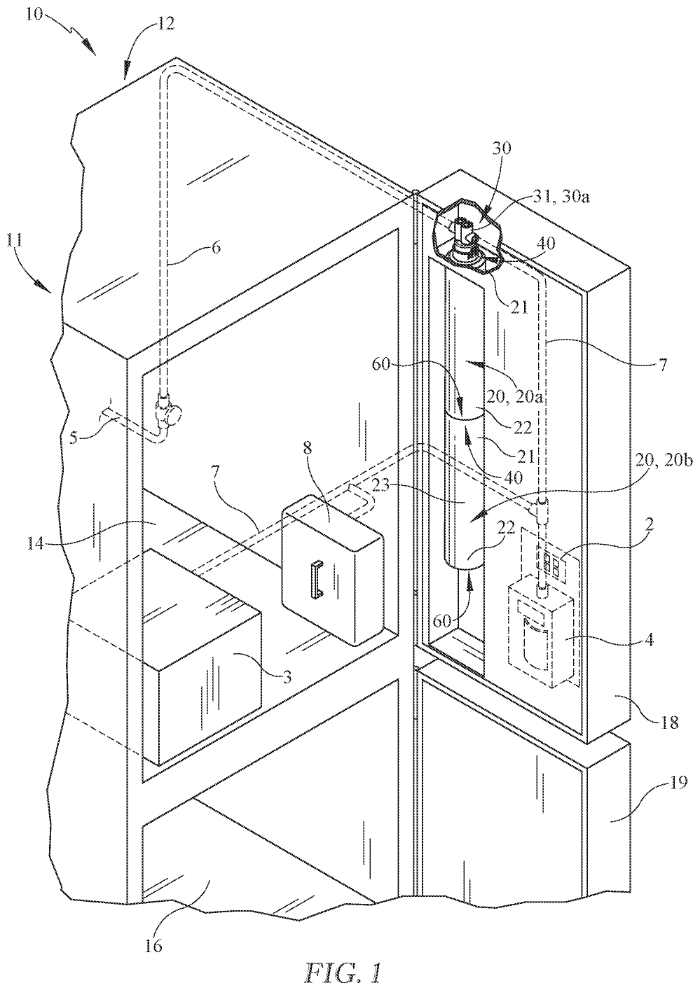

Turning now to the drawings, wherein like numbers denote like parts throughout the several views, FIG. 1 illustrates an example refrigerator 10 in which the various technologies and techniques described herein may be implemented. Refrigerator 10 is a residential-type refrigerator, and as such includes a cabinet 11 including a case 12 (representing the fixed portion or main body of the refrigerator) having/defining one or more food storage compartments (e.g. a fresh food compartment 14 and a freezer compartment 16), as well as one or more fresh food compartment doors 18 and one or more freezer compartment doors 19 disposed adjacent respective openings of food storage compartments 14, 16 and configured to insulate/access the respective food storage compartments 14, 16 from an exterior environment when the doors are closed.

Fresh food compartment 14 is generally maintained at a temperature above freezing for storing fresh food such as produce, drinks, eggs, condiments, lunchmeat, cheese, etc. Various shelves, drawers, and/or sub-compartments may be provided within fresh food compartment 14 for organizing foods, and it will be appreciated that some refrigerator designs may incorporate multiple fresh food compartments and/or zones that are maintained at different temperatures and/or at different humidity levels to optimize environmental conditions for different types of foods. Freezer compartment 16 is generally maintained at a temperature below freezing for longer-term storage of frozen foods, and may also include various shelves, drawers, and/or sub-compartments for organizing foods therein.

Refrigerator 10 as illustrated in FIG. 1 is a type of bottom mount refrigerator. Both the fresh food compartment and the freezer compartment may be considered to be full width as they extend substantially across the full width of the case 12. It will be appreciated, however, that a variety of compartment door designs may be used in other embodiments, including various combinations and numbers of hinged and/or sliding doors for each of the fresh food and freezer compartments (e.g., a pair of French freezer doors, a single sliding freezer door, or one hinged fresh food and/or freezer door). Moreover, while refrigerator 10 is a bottom mount refrigerator with freezer compartment 16 disposed below fresh food compartment 14, the invention is not so limited, and as such, the principles and techniques may be used in connection with other types of refrigerators in other embodiments, e.g., top mount refrigerators, side-by-side refrigerators, etc. Further, other appliances besides refrigerators may be used and still be within the scope of the invention. For example, a stand-alone water systems/appliances (e.g. dispensers, under sink, water fountains) may be used.

In some implementations, the refrigerator 10 may include one or more dispensers 4 for dispensing ice and/or a fluid such as water. The dispenser may be accessible internal or external to the refrigerator. In the illustrated embodiments, dispenser 4, external, is an ice and water dispenser capable of dispensing both ice (cubed and/or crushed) and chilled water, while in other embodiments, dispenser 4 may be a fluid only dispenser for dispensing various fluids such as chilled or cooled water, hot water, coffee, beverages, or other fluids, and may have variable rate and/or fast dispense capabilities, as well as an ability to dispense predetermined or measured quantities of fluids. In some instances, ice and water may be dispensed from the same location, while in other instances separate locations may be provided in the dispenser for dispensing ice and water.

In some implementations, one or more ice makers 3 may be used to receive water and to make ice from the received water. Further, in some embodiments, the water supply may be in fluid communication with removable containers, storage tanks, etc. internally/externally to the refrigerator. To this end, the refrigerator is also provided with a water supply tube/line 6 to supply water from an external water supply source 5 to the water cartridge(s) 20, refrigerator cartridge head assembly 30, and a water discharge tube/line 7 to supply water customized by the one or more water cartridges to the ice maker 3 and dispenser 4, or the like. The embodiments shown and described can be utilized with many types and styles of refrigerators and/or refrigerator cartridge head assemblies, including, without limitation, described in U.S. Pat. No. 9,115,920, issued Aug. 25, 2015, and CN218511279, published Feb. 21, 2023, the entire contents of which are incorporated herein by reference.

Refrigerator 10 may include a control panel, which in the illustrated embodiment forms at least a portion of the dispenser 4. Control panel 2 may include various input/output controls such as buttons, indicator lights, alphanumeric displays, dot matrix displays, touch-sensitive displays, etc. for interacting with a user. In other embodiments, control panel 2 may be separate from dispenser 4 (e.g. on a door), and in other embodiments, multiple control panels may be provided. Further, in some embodiments audio feedback may be provided to a user via one or more speakers, and in some embodiments, user input may be received via a spoken or gesture-based interface. Additional user controls may also be provided elsewhere on refrigerator 10, e.g., within fresh food and/or freezer compartments 14, 16. In addition, refrigerator 10 may be controllable remotely, e.g., via a smartphone, tablet, personal digital assistant or other networked computing device, e.g., using a web interface or a dedicated app.

A refrigerator consistent with the invention also generally includes one or more controllers configured to control a refrigeration system as well as manage interaction with a user. A refrigerator 10 may include a controller that receives inputs from a number of components (e.g. water cartridge(s)) and drives a number of components in response thereto. Controller may, for example, include one or more processors and a memory within which may be stored program code for execution by the one or more processors. The memory may be embedded in controller, but may also be considered to include volatile and/or non-volatile memories, cache memories, flash memories, programmable read-only memories, read-only memories, etc., as well as memory storage physically located elsewhere from controller, e.g., in a mass storage device or on a remote computer interfaced with controller.

A controller may be interfaced with various components, including a cooling or refrigeration system, an ice/water system (e.g. water cartridge, dispenser, ice maker, water delivery/handling devices, etc.), one or more user controls for receiving user input (e.g., various combinations of switches, knobs, buttons, sliders, touchscreens or touch-sensitive displays, microphones or audio input devices, image capture devices, etc.), and one or more user displays (including various indicators, graphical displays, textual displays, speakers, etc.), as well as various additional components suitable for use in a refrigerator, e.g., interior and/or exterior lighting, among others. At least a portion of user controls and user displays may be disposed, for example, on control panel 2 of FIG. 1.

Controller may also be interfaced with various sensors located to sense environmental conditions inside of and/or external to refrigerator 10, e.g., one or more temperature sensors, humidity sensors, water cartridge 20, etc. Such sensors may be internal or external to refrigerator 10, and may be coupled wirelessly to controller in some embodiments. Sensors may also include additional types of sensors such as door switches, switches that sense when a portion of an ice dispenser and/or water cartridge(s) has been removed, type(s) of water cartridge being used, and other status sensors, as will become more apparent below.

In some embodiments, controller may also be coupled to one or more network interfaces, e.g., for interfacing with external devices via wired and/or wireless networks such as Ethernet, Wi-Fi, Bluetooth, NFC, cellular and other suitable networks. Network may incorporate in some embodiments a home automation network, and various communication protocols may be supported, including various types of home automation communication protocols. In other embodiments, other wireless protocols, e.g., Wi-Fi or Bluetooth, may be used.

In some embodiments, refrigerator 10 may be interfaced with one or more user devices over network, e.g., computers, tablets, smart phones, wearable devices, etc., and through which refrigerator 10 may be controlled and/or refrigerator 10 may provide user feedback.

In some embodiments, the controller may operate under the control of an operating system and may execute or otherwise rely upon various computer software applications, components, programs, objects, modules, data structures, etc. In addition, controller may also incorporate hardware logic to implement some or all of the functionality disclosed herein. Further, in some embodiments, the sequences of operations performed by controller to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

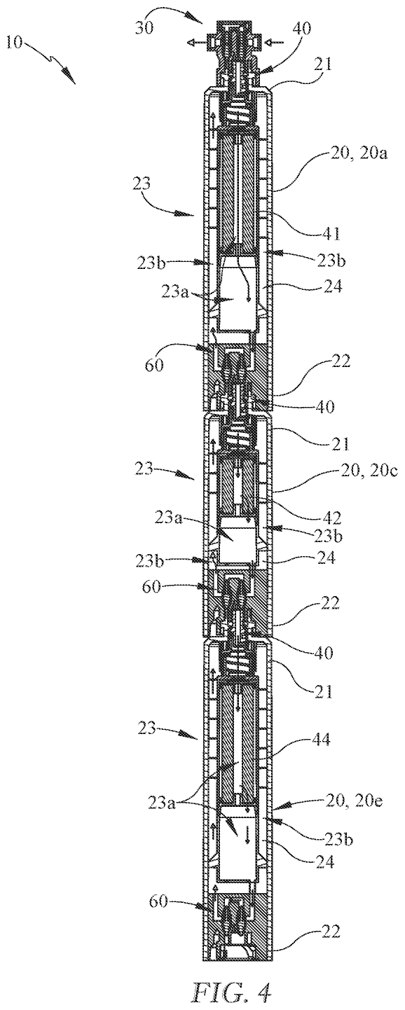

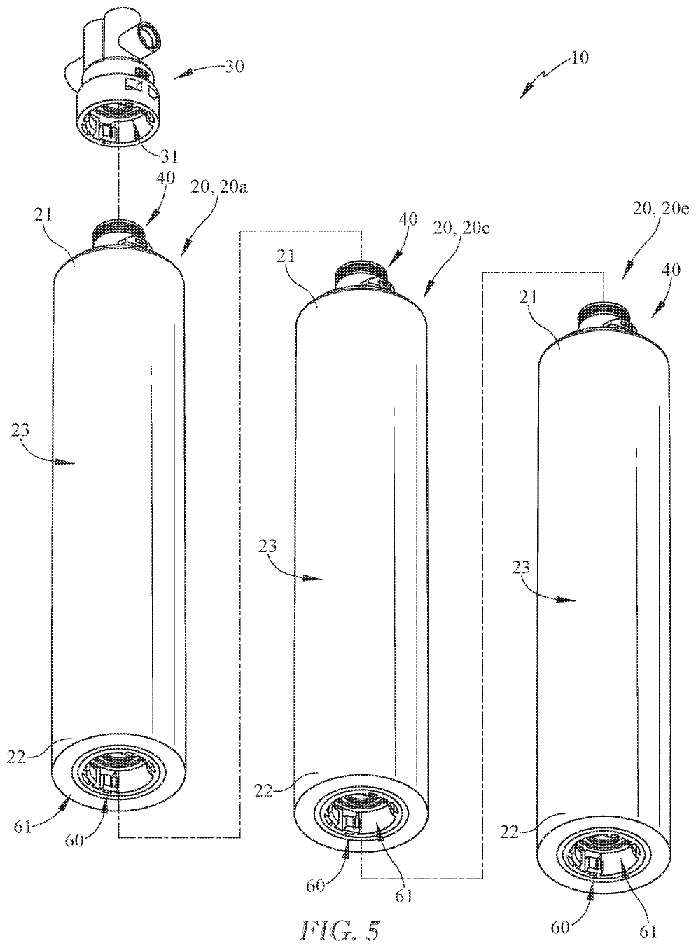

Now turning to FIGS. 1-5, in some embodiments, one or more water cartridges 20 may be used in fluid communication with the water supply (e.g. external water supply source 5, internal) of the refrigerator 10. The one or more water cartridges 20 (e.g. first 20a, second 20b, third 20c, fourth 20d, etc.) may be used alone, in fluid communication with another water cartridge, or in a particular upstream/downstream configuration to effect a change and/or provide/remove different properties to the water supply of the refrigerator. The one or more water cartridges 20 may customize the water therein for/with purity, filtration, flavoring, sanitization, additive, removal, color, temperature, storage capacity, etc. For example, a first water cartridge 20a may include a first filter 41 (e.g. one or more properties). A second water cartridge 20b may include a second filter (e.g. one or more properties). The first filter 41 may be the same or different from the second filter of the second water cartridge 20b. A third water cartridge 20c may include a flavoring 42 (e.g. grape, lemon, lime, etc.). A fourth water cartridge 20d may include a tank/reservoir 43 (e.g. first volume, second volume, third volume, etc.). A fifth water cartridge 20e may include an additive or sanitizer 44 (e.g. chlorine, fluoride, disinfectants, carbonation, sweetener, coloring, medicine, caffeine, alcohol, etc.). Further, the order or sequence and/or quantity of the one or more water cartridges 20 may effect a change to the water supply of the refrigerator or achieve a predetermined or desired consumer outcome. For example, a single water cartridge may be used to change one or more properties of the water. Further, in some implementations as shown in FIGS. 1-3, two water cartridges 20 (e.g. in series) may be used/connected/assembled together. The first water cartridge (e.g. 20a) may be the same or different from the second water cartridge (e.g. 20d). For example, the upstream or first water cartridge 20a may include a first filter 41 and the downstream or second water cartridge 20b may include a tank 43 (e.g. sanitizer 44, second filter 41, or flavoring 42). Alternatively, the second water cartridge may be positioned upstream of the first water cartridge in some embodiments. Further, for example as shown in FIGS. 4 and 5, three or more water cartridges 20 (e.g. in series) may be used or coupled (e.g. fluidly) together. One or more of the three water cartridge may be the same or different from the remaining water cartridges. As shown in the one embodiment in FIGS. 4 and 5, the upstream or first water cartridge 20a may include a filter 41, the middle or second water cartridge 20 (e.g. 20c) may include a flavoring 42, and the last, downstream or third water cartridge 20 (e.g. 20c) may include an additive/sanitizer 44. Alternatively, the upstream or first water cartridge may include a sanitizer, the middle or second water cartridge may be a tank, and the last, downstream or third water cartridge may include a flavoring. These examples of order/sequence/quantity of water cartridge's contents should not be construed as limiting, other configurations and/or properties may be added/removed from or used with the water supply.

The one or more water cartridges 20, or portions thereof, may be a variety of shapes, sizes, quantities, properties, constructions, and/or positions in the appliance (e.g. relative to one or more water handling/delivery devices 50) and still be within the scope of the invention. For example, one water cartridge 20 may be used, two water cartridges 20 may be used, three water cartridges 20 may be used, four water cartridges 20 may be used, or five or more water cartridges 20 may be used. Further, filters of different sizes (e.g. lengths) may be used/coupled together. For example, two half sized filters (e.g. small length) in length may be coupled together to fill/replace a fluid position/length of a longer length cartridge (e.g. large length filter).

In some implementations, the one or more water cartridges 20 may be in fluid communication with one or more water delivery/handling devices 50 (e.g. internal, external) of the refrigerator 10, such as but is not limited to one or more ice makers 3, one or more dispensers 4, one or more containers/tanks 8 (e.g. removable, non-removeable, internal, external), filter, etc. Although the one or more water cartridges 20 are shown as positioned within the door 18, it should be understood that the one or more water cartridges may be in a variety of positions with the refrigerator 10. For example, the one or more water cartridges 20 may be positioned in the casing/housing 12. Further, the one or more water cartridges 20 and/or one or more refrigerator cartridge head assemblies 30 may be positioned upstream from one or more handling/delivery devices 50 and/or downstream from one or more handling/delivery devices 50. Although the one or more water cartridges are shown vertically orientated or in communication with each other, other orientations are still within the scope of the invention. For example, the one or more water cartridges may be horizontally orientated in some embodiments.

In some implementations, the refrigerator 10 and/or water system, or portions thereof, may include one or more cartridge head assemblies (e.g. refrigerator). The refrigerator cartridge head assembly 30, if used, and/or water cartridge(s) 20 may be in fluid communication with at least one water supply line 6 (e.g. upstream) and/or at least one water discharge line 7 (e.g. downstream). The refrigerator cartridge head assembly 30 and/or water cartridge(s) 20 may be upstream of the one or more water handling/delivery devices 50 (e.g. ice maker, dispenser, storage tanks, filters, containers, etc.). Alternatively, or in combination with, the refrigerator cartridge head assembly 30 and/or water cartridge(s) 20 may be downstream of one or more water handling/delivery devices. The refrigerator cartridge head assembly 30, or portions thereof, may releasably couple (e.g. fluid communication) with one or more water cartridges 20. The refrigerator cartridge head assembly may be a variety of shapes, sizes, quantities, constructions, and orientations/positions within the refrigerator and still be within the scope of the invention.

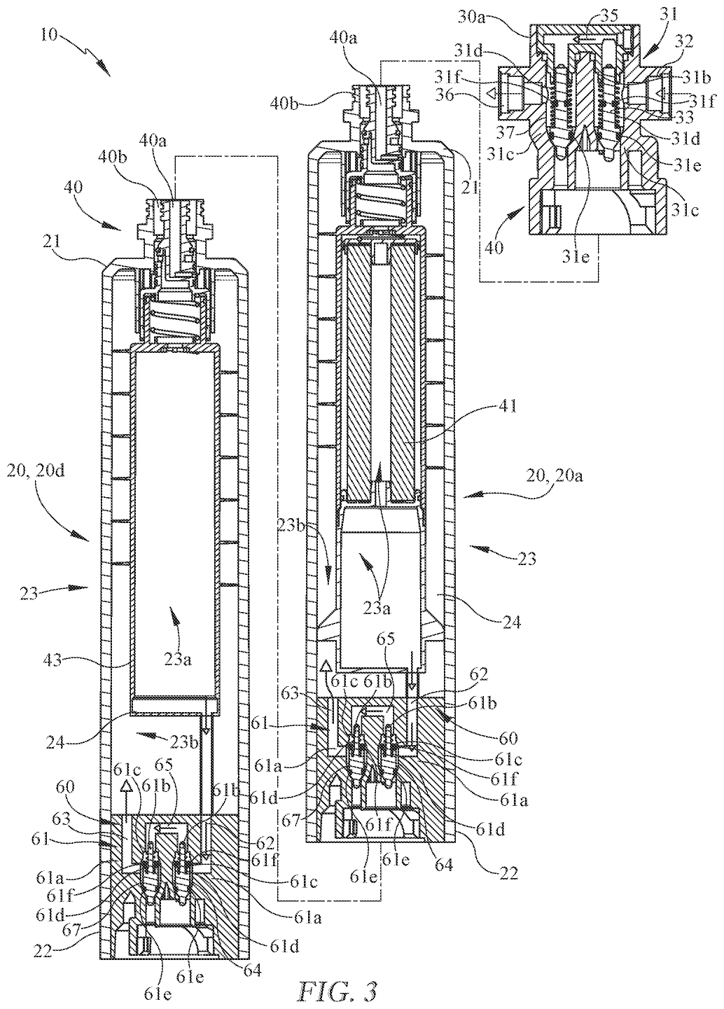

In some implementations, a water cartridge and/or refrigerator, or portions thereof, may include/define/actuate one or more valves 31, or portions thereof, that may fluidly connect (e.g. open, close) the water cartridge with the refrigerator. In the one embodiment shown in the figures, the refrigerator cartridge head assembly 30 may be or include one or more valves 31 that may be in a first configuration or normally open (e.g. bypass passage open) in fluid communication between the water supply line 6 and the water discharge line 7 and a second configuration (e.g. bypass passage closed) in fluid communication with the one or more water cartridges 20. The first configuration may occur when the one or more water cartridges 20 is disconnected from the refrigerator cartridge head assembly 30 (see FIGS. 3 and 5). The second configuration may occur when the one or more water cartridges 20 (e.g. coupler) is coupled to the refrigerator cartridge head assembly 30 (see FIGS. 1, 2, and 4. Further in the second configuration, the water is in fluid communication from the water supply line 6 through the refrigerator cartridge head assembly 30, the one or more water cartridges 20, and then through the refrigerator cartridge head assembly 30 to the water discharge line 7. When in the second configuration or coupled to the refrigerator cartridge head assembly 30, the one or more water cartridges 20 are in fluid communication with each other (e.g. in series) between the water supply line and the water discharge line. Although not shown, the cartridges may be in parallel communication in some embodiments.

In some implementations as shown in FIGS. 1, 2, and 4, refrigerator cartridge head assembly 30 may be releasably coupled to the one or more water cartridges 20 in the second configuration. A body 30a of the refrigerator cartridge head assembly 30 may be provided with a first inlet 32 and a first inlet passage 33, through which water from the water supply source 5 and/or water supply line 6 is introduced. The body 30a is also provided with a first outlet 36 and a first outlet passage 37, through which water treated or circulated through the one or more water cartridges 20 is discharged to the water handling/delivery devices 50 and/or water discharge line 7. A bypass passage 35, which communicates the first inlet passage 33 and first outlet passage 37 when the one or more water cartridges 20 are disconnected therefrom or when in a first configuration, is also provided at the body 30a.

In some implementations when the one or more water cartridges 20 are coupled with the refrigerator cartridge head assembly 30 or body 30a, the water cartridge 20 (e.g. first) or body 23/coupler 40 (e.g. first) is received in or coupled to the body 30a or refrigerator cartridge head assembly 30. The coupler 40, if used, may include one or more passages. The coupler or body 40 (e.g. first) is formed with a first communicating passage 40a to communicate the first inlet passage 33 and the water cartridge 20 (e.g. first, interior, one or more portions/chambers) and downstream water cartridges 20 (e.g. second, third, etc., interior, one or more portions/chambers), if any, and a second communicating passage 40b to communicate the first outlet passage 37 and the water cartridge (e.g. first, interior) and downstream water cartridges (e.g. second, third, etc.), if any.

In some implementations, the refrigerator cartridge head assembly 30, valves 31, and/or body 30a may include one or more valve units 31a are provided at each of the communicating passages 33 and 37. The valve units 31a function to open or close the first inlet passage 33 and first communicating passage 40a, and the first outlet passage 37 and second communicating passage 40b, respectively.

In some implementations, each valve unit 31a includes a valve stem 31b, a support member 31c to support the valve stem 31b, a first elastic member 31d to elastically support the valve stem 31b between the valve stem 31b and the support member 31c, and a second sealing member 31e and a third sealing member 31f arranged around an outer peripheral surface of the valve stem 31b. The first elastic member 31d elastically supports the valve stem 31b when the water cartridge 20 is mounted to or separated from the refrigerator cartridge head assembly 30. Third sealing members 31f seal off or closes the bypass passage 35 (e.g. second configuration, unsealed second sealing member 31e) to allow water to flow from the first inlet passage 33 into the first communication passage 40a, now open, or coupler/water cartridge and into the interior 24 (e.g. inner portion, outer portion) or body 23 of the first water cartridge and into the second communication passage 40b, now open, or coupler 40 before returning through the first outlet passage 37. The third sealing members 31f unseal or opens the bypass passage 35 (e.g. first configuration) to allow water to flow through the bypass while closing the first inlet/outlet passages 33, 37 via the second sealing members 31e.

In some implementations, the coupler 40 of the water cartridge 20 is fitted in the body 30a of the refrigerator cartridge head assembly 30. When the coupler 40 is rotated (e.g. 90°) after being fitted into the socket/body 30a, the coupler 40 (e.g. male) is engaged with the refrigerator cartridge head assembly or body (e.g. female), so that the coupler or water cartridge is coupled to the refrigerator cartridge head assembly.

In some implementations, the water cartridge 20, or portions thereof, (e.g. coupler) actuate the one or more valves 31 or the refrigerator cartridge head assembly 30 when coupling thereto. When in the first configuration, the valve units maintain the bypass passage 35 in the open position, and the first inlet/outlet passages 33, 37 are closed, and when in the second configuration when the water cartridge 20 is engaged to the refrigerator cartridge head assembly 30 the valve(s) (e.g. valve units) allow water to flow from the first inlet passage 33 into the first communication passage 40a, now open, or coupler/water cartridge and into the interior 24 (e.g. inner portion, outer portion) or body 23 of the first water cartridge and into the second communication passage 40b, now open, or coupler 40 before returning through the first outlet passage 37.

In some implementations, two or more water cartridges 20 may be connected, assembled, or in fluid communication with each other. The two or more water cartridges 20 may releasably connect/assemble to the refrigerator cartridge head assembly 30 in fluid communication. The one or more water cartridges 20 may be connected to the water supply (e.g. refrigerator cartridge head assembly) at a single location as shown in the one embodiment. The water may flow into the first water cartridge 20a before entering the downstream water cartridge (e.g. second 20b-20h, etc.). If a third water cartridge 20c is connected in fluid communication with the second water cartridge 20b, the water may flow into the third water cartridge after the second water cartridge. The two or more water cartridges may be connected to each other (e.g. in series, end to end). A first water cartridge may connect to a second water cartridge, a third water cartridge, etc.

In some implementations, a water cartridge (e.g. first, second, third, etc.) may include a body/housing 23 (e.g. elongated, cylindrical) having a first/upstream end 21 and an opposing second/downstream end 22. The water cartridge (e.g. first) may include a coupler 40 (e.g. first) on the first end 21 configured to releasably engage/connect to the refrigerator cartridge head assembly 30 and/or another water cartridge 20 (e.g. cartridge head assembly 60 of another/second water cartridge). The coupler 40 may be a variety of shapes, sizes, quantities, and constructions and still be within the scope of the invention to releasably/fluidly couple to the refrigerator cartridge head assembly 30 and/or another water cartridge 20 (e.g. second end, cartridge head assembly 60). The water cartridge 20 (e.g. first) may include a cartridge head assembly 60 (e.g. first) on the second end 22 to releasably engage or configure to receive the coupler 40 (e.g. second) of another/second water cartridge 20. The cartridge head assembly 60 of the water cartridge may be a variety of shapes, sizes, quantities, and constructions and still be within the scope of the invention to releasably couple to another/downstream water cartridge (e.g. first end, coupler).

In some implementations, an upstream water cartridge and/or a downstream water cartridge, or portions thereof, may include/define/actuate one or more valves 61, or portions thereof, that may fluidly connect (e.g. open, close) the upstream water cartridge with the downstream water cartridge. In the one embodiment shown in the figures, the water cartridge 20 and/or cartridge head assembly 60 may include a first configuration and a second configuration wherein one or more valves 61 are operated between open and closed positions. When in the first configuration an inlet passage 64 and outlet passage 67 of the cartridge head assembly is closed and the bypass passage 65 is open. When in the second configuration the outlet passage 67 and/or inlet passage 64 of the cartridge head assembly 60 is open, with the bypass passage 65 closed, and configured to be in fluid communication with a second water cartridge. In the first configuration, one or more valves 61 (e.g. value units) of the cartridge head assembly 60 are normally closed when the downstream water cartridge (e.g. coupler) is not connected to the cartridge head assembly 60 of the upstream water cartridge. In the second configuration when the coupler 40 or another water cartridge 20 is connected (e.g. fluidly) to the cartridge head assembly, the one or more valves 61 (e.g. valve units 61a) and/or passages (e.g. 64, 67) are open to be in fluid communication with the downstream water cartridge (e.g. interior 24, contents, volume, etc.). The valve unit 61a may include a stem 61b, support member 61c, elastic member 61d, sealing member 61f, and/or sealing member(s) 61e in some embodiments.

In some implementations, a second water cartridge 20b (e.g. 20c-20-h, etc.), if used, may have a housing 23 having a first end 21 and a second end 22. The first end 21 of the second water cartridge 20b may include a second coupler 40 releasably connected to the cartridge head assembly 60 (e.g. first) of a first/upstream water cartridge 20a between a first configuration wherein the second water cartridge is not in fluid communication with the first cartridge head assembly 60 and/or first water cartridge 20a (see FIGS. 3 and 5) and a second configuration wherein the second water cartridge 20b is in fluid communication with the first cartridge head assembly 60 and/or first water cartridge 20a (see FIGS. 1, 2, and 4). Coupling or engaging the second water cartridge 20b (e.g. second coupler), with or without additional water cartridges 20, to the first cartridge head assembly 60 actuates the one or more valves 61 (e.g. units, passages, inlet, outlets) from the closed/first configuration to the open/second configuration. In the second configuration, the downstream water cartridge(s) 20b is in fluid communication downstream of the refrigerator cartridge head assembly 30, first water cartridge 20a (e.g. inner portion, outer/downstream portion), first coupler 40/cartridge head assembly 60 of the first water cartridge 20a, inlet passage and/or outlet passage of the first coupler 40, and/or inlet/outlet of the refrigerator cartridge head assembly 30. The interior 24 or function (e.g. properties applied to or removed from the water supply) of the first water cartridge and the second/additional water cartridge(s) may be different or the same in some embodiments. The user may select the type/function/sequence/quantities of the water cartridge(s) for one or more applications, or in some implementations it may be predetermined. Further, the user may replace/change/add/remove one or more water cartridges 20 to change the properties of the water supply/system of the refrigerator in some embodiments.

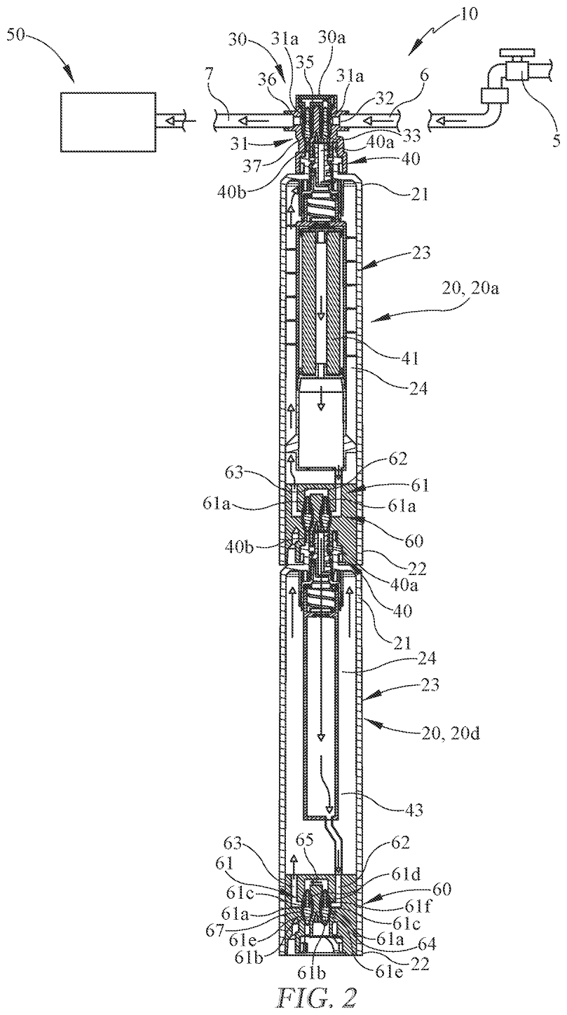

In some implementations, the water cartridge 20, or portions thereof, (e.g. coupler) actuate the one or more valves 61 or the cartridge head assembly 60 when coupling thereto. When in the first configuration, the valve units 61 maintain the bypass passage 65 in the open position, and the inlet/outlet passages 64, 67 are closed. The sealing members 61f are unsealed with the bypass passage 65, while the sealing members 61e engage and seal the inlet/outlet passages 64, 67. The bypass passage is in fluid communication between the inner portion/chamber 23a and the outer portion/chamber 23b when no downstream water cartridge is fluidly connected. As such, the fluid may then flow from the outer portion 23b into the upstream coupler 40, upstream water cartridge (e.g. 60, 23b), if any, and/or refrigerator cartridge head assembly 30. When in the second configuration when the second water cartridge 20b is engaged to the cartridge head assembly 60 the valve(s) (e.g. valve units 61) allow water to flow from the inner portion/chamber 23a of the first water cartridge 20a and the inlet 62/inlet passage 63 into the first communication passage 40a, now open, or downstream coupler/water cartridge 20b and into the inner portion 23a or body 23 of the second water cartridge 20b and into the outer portion 23b of the second water cartridge, if the bypass passage 65 is open (e.g. no more downstream water cartridges are connected). The flow of fluid then continues from the outer portion 23b of the second water cartridge 20b through the second communication passage 40b, now open, or coupler 40 before returning through the outlet 63/outlet passage 67 to the first water cartridge 20a (e.g. outer portion 23b). Alternatively if the bypass passage 65 is closed, for example, by coupling a third water cartridge 20c, the water would flow from the inner portion 23a of the second water cartridge 20b through the now open inlet 62 or inlet passage 63 of the cartridge head assembly 60 of the second water cartridge 20b to the inner portion 23a of the third water cartridge 20c via the coupler 40 of the third water cartridge 20c. For example, as shown in FIG. 2, the cartridge head assembly 60 of the fourth water cartridge 20d is in the first configuration, wherein the bypass passage 65 is open and the inlet/out passages 64, 67 are closed, and the cartridge head assembly 60 of the first water cartridge 20a is in the second configuration, wherein the bypass passage 65 is closed and the inlet/out passages 64, 67 are open. Further for example, as shown in FIG. 4, the cartridge head assembly 60 of the fifth water cartridge 20e is in the first configuration, wherein the bypass passage 65 is open and the inlet/out passages 64, 67 are closed, and the cartridge head assembly 60 of the first water cartridge 20a and third water cartridge 20c is in the second configuration, wherein the bypass passage 65 is closed and the inlet/out passages 64, 67 are open.

In some implementations, if a second water cartridge is used in combination with a first water cartridge the first coupler and the second coupler may be the same. Further, in some embodiments, the first cartridge head assembly and the second cartridge head assembly may be the same. Alternatively, in some implementations, the water cartridges, or portions thereof, may be different. For example, the couplers and/or cartridge head assemblies may be different. Although the refrigerator cartridge head assembly is shown as different than the cartridge head assembly of the water cartridge, they may be the same in some embodiments.

In use, the refrigerator 10 may supply water to the one or more water delivery/handling devices 50 when one or more water cartridges 20 are not connected to or in the first configuration with the refrigerator cartridge head assembly 30. When the user connects one or more water cartridges 20 to at least one refrigerator cartridge head assembly 30, the refrigerator head cartridge head assembly is in fluid communication with the one or more water cartridges in the second configuration. A single water cartridge may be connected to the refrigerator cartridge head assembly 30 in some applications. In other applications, the user or refrigerator may connect a plurality of water cartridges to the refrigerator cartridge heads assembly 30. Fluidly/releasably connecting the coupler 40, first end 21, or water cartridge 20 to the refrigerator cartridge head assembly 30 or cartridge head assembly 60, second end 22, or another water cartridge(s) actuates the one or more valves 31, 61 (e.g. inlet, outlets, passageways(s)) between a closed position and an open position. One or more of water cartridges 20 or couplers 40 may be fluidly/releasably disconnected from the refrigerator cartridge head assembly 30 or cartridge head assembly 60, second end 22, or another water cartridge(s) 20 actuating the one or more valves 31, 61 (e.g. inlet, outlets, passageways(s)) between a closed position and an open position. The water supply may be customized by selecting the contents/function/properties of the one or more water cartridges 20. For example, the water cartridges (e.g. combined end to end, in one or more quantities, in one or more orders) may include a filter, a water/storage tank, a sanitizer, and/or additive or the like in one or more combinations to provide different properties to the water supply and/or one or more water delivery/handling devices. Further, the user may change/remove the order and/or contents of the water cartridges to achieve different properties. Further, the user may replace one or more water cartridges to achieve different properties or to replenish the contents of the replaced water cartridge to achieve the same properties. For example, if a grape flavor water cartridge is depleted the user may replace with another grape flavor water cartridge/refill or replace with an orange flavor water cartridge.

It should be understood that the releasable couplings between water cartridges and/or between the water cartridge and the refrigerator (e.g. refrigerator cartridge head assembly, water supply) may be of a variety of shapes, sizes, quantities, constructions, positions, movement to lock/unlock, and flow passages and still be within the scope of the invention. For example, a variety of valves may be used. Further, the coupling to engage/disengage may be a push and turn engagement in some embodiments. For example, one or more seals may be used.

It will be appreciated that various additional modifications may be made to the embodiments discussed herein, and that a number of the concepts disclosed herein may be used in combination with one another or may be used separately. Therefore, the invention lies in the claims hereinafter appended.

1. A refrigerator, comprising:
a cabinet including a case having one or more food storage compartments defined therein and one or more doors positioned to access the one or more food storage compartments from an exterior environment, and the cabinet further including a refrigerator cartridge head assembly in fluid communication with a water supply; and
one or more water cartridges, wherein at least a first water cartridge of the one or more water cartridges includes a housing having a first end and a second end, wherein the first end includes a first coupler releasably connected to the refrigerator cartridge head assembly between a first configuration wherein the first water cartridge is not in fluid communication with the refrigerator cartridge head assembly and a second configuration wherein the first water cartridge is in fluid communication with the refrigerator cartridge head assembly, wherein the second end includes a first cartridge head assembly, and wherein the first cartridge head assembly is configured to receive a second coupler of a second water cartridge.

2. The refrigerator of claim 1 wherein the one or more water cartridges includes a filter, a water tank, a sanitizer, and/or an additive.

3. The refrigerator of claim 1 further comprising a second water cartridge having a housing having a first end and a second end, wherein the first end includes a second coupler releasably connected to the first cartridge head assembly between a first configuration wherein the second water cartridge is not in fluid communication with the first cartridge head assembly and a second configuration wherein the second water cartridge is in fluid communication with the first cartridge head assembly.

4. The refrigerator of claim 3 wherein the first coupler and the second coupler is the same.

5. The refrigerator of claim 1 wherein the first cartridge head assembly includes a first configuration and a second configuration, when in the first configuration an inlet passage of the first cartridge head assembly is closed and when in the second configuration the inlet passage of the first cartridge head assembly is open and configured to be in fluid communication with a second water cartridge.

6. The refrigerator of claim 1 wherein two or more of the one or more water cartridges are in fluid communication with each other in series between a water supply line and a water discharge line connected to the refrigerator cartridge head assembly.

7. The refrigerator of claim 1 further comprising a dispenser, a container, and/or an ice maker in downstream communication with the refrigerator cartridge head assembly.

8. The refrigerator of claim 7 wherein two or more of the one or more water cartridges provide different properties to the water supply.

9. A water cartridge for a refrigerator comprising:
a housing having a first end and a second end, wherein the first end includes a first coupler configured to be releasably connected to a refrigerator cartridge head assembly of a refrigerator between a first configuration configured to not be in fluid communication with a refrigerator cartridge head assembly and a second configuration configured to be in fluid communication with a refrigerator cartridge head assembly, wherein the second end includes a cartridge head assembly; and
wherein the cartridge head assembly is configured to receive a second coupler of a second water cartridge.

10. The water cartridge of claim 9 further comprising a second water cartridge having a housing having a first end and a second end, wherein the first end includes a second coupler releasably connected to the cartridge head assembly between a first configuration wherein the second water cartridge is not in fluid communication with the cartridge head assembly and a second configuration wherein the second water cartridge is in fluid communication with the cartridge head assembly.

11. The water cartridge of claim 9 wherein the cartridge head assembly includes a first configuration and a second configuration, when in the first configuration an inlet passage of the cartridge head assembly is closed and when in the second configuration the inlet passage of the cartridge head assembly is open and configured to be in fluid communication with a second water cartridge.

12. The water cartridge of claim 9 further includes a filter, a water tank, a sanitizer, and/or an additive.

13. The water cartridge of claim 12 further includes the water tank, the sanitizer, and/or the additive.

14. The water cartridge of claim 9 includes a downstream water cartridge that is in fluid communication between an inlet and an outlet of the first coupler.

15. The water cartridge of claim 14 is different than the downstream water cartridge.

16. A method of assembling two or more water cartridges in fluid communication comprising the steps of:
providing a first water cartridge having a housing having a first end and a second end, wherein the first end includes a first coupler and wherein the second end includes a first cartridge head assembly;
providing a second water cartridge having a housing having a first end and a second end, wherein the first end includes a second coupler and wherein the second end includes a second cartridge head assembly; and
releasably connecting the second coupler of the second water cartridge in fluid communication with the first cartridge head assembly.

17. The method of claim 16 wherein the first cartridge head assembly includes a first configuration and a second configuration, when in the first configuration an outlet of the first cartridge head assembly is closed and when in the second configuration the outlet of the first cartridge head assembly is open and configured to be in fluid communication with the second water cartridge.

18. The method of claim 16 further including releasably connecting a third water cartridge to the second cartridge head assembly.

19. The method of claim 16 further comprising coupling the first water cartridge and the second water cartridge to a refrigerator cartridge head assembly of a refrigerator in fluid communication between a water supply line and a water discharge line.

20. The method of claim 16 further comprising releasably disconnecting the second coupler of the second water cartridge out of fluid communication with the first cartridge head assembly.
